(19) United States
(12) Patent Application Publication
(10) Pub. No.: US 2001/0042167 A1
(43) Pub. Date: Nov. 15, 2001

(54) METHOD OF STORING DATA AND DATA STORAGE DEVICE USING THE SAME

(76) Inventor: HIROICHI EGAWA, KAWASAKI-SHI (JP)

Correspondence Address: HELFGOTT & KARAS, 60TH FLOOR, EMPIRE STATE BUILDING, NEW YORK, NY, 101180110

(21) Appl. No.: 08/841,871

(22) Filed: May 2, 1997

(30) Foreign Application Priority Data
Aug. 27, 1996 (JP) 8-224943

(51) Int. Cl. G06F 12/00

(52) U.S. Cl. 711/114; 725/145

(57) ABSTRACT

When data of a file are stored in a disk drive unit, the data are divided and stored in a plurality of disk drive units, so that the data more than physical capacity of a disk drive unit may be stored by the striping method. The method for storing the data may include the steps of allocating unique information identifying a disk drive unit to each of a plurality of disk drive units composing a disk group, specifying one of the plurality of disk drive units as a parent disk drive unit, storing information indicating the relation between the disk drive units which compose the group in said parent disk drive unit, dividing data of a file into a plurality of divided, and storing said divided data in the plurality of disk drive units, as logically continued.

### BACKGROUND OF THE INVENTION

1. Field of the Invention

The present invention relates to a method for storing data in a plurality of disk drive units which compose a group and a data storage device which uses the method.

More particularly, it relates to a method for storing data of a file in two or more disk drive units, that are, hard disk devices, by dividing the data, and a data storage device which uses the method.

2. Related art

Capacity of a disk drive unit as a storage device has been increased year by year, and disk drive unit has been further developed and improved. Moreover, it is the tendency that data size of a file, which is stored in a disk drive unit has become large, as represented by size of digitalized data of a motion picture image.

Thus, the size of data stored in a disk drive unit and the capacity of the disk drive unit are in the tendency of becoming large synergistically, and then the size of data treated may become larger than the physical storing capacity of a disk drive unit.

In addition, a Video On Demand (VOD) service system has been in the stage of practical use in recent years. A plurality of disk drive units are required for a server device of the VOD service system, and the server device has a plurality of video data files stored as a video library. And, the server device reads out and transmits requested video data read out from the video library to requesting clients.

It is often necessary to store data of a file more than physical capacity of a disk drive unit in such the server device. In the VOD service system, it is, therefore, necessary to store data of a file, in a plurality of disk drive units in order to reduce a waiting time for requests from many clients or not to allocate a same disk drive unit to a same client for a long time, and it is also necessary to administrate the plurality of disk drive units.

Data of a file are divided, and a disk system or file system in the VOD service system may treat the divided data. Then, the divided data are stored into the plurality of disk drive units, so that data more than physical capacity of a disk drive unit may be stored.

Moreover, a plurality of disk drive units are administrated by an administration method as if one disk drive unit, which will be called as a logical disk unit, hereafter, is virtually used.

In general, the administration method is called as striping technology. The outline of such the striping technology is explained as shown in FIG. 6. That is, when a file having the file name “abcd.dat”, and a file size which cannot be physically stored in one disk drive unit is treated, data of the file are stored in a plurality of disk drive units (disks 1, 2, 3, and 4) and the plurality of disk drive units treat the file as if logically one disk drive unit treats the file.

The data of the file “abcd.dat” are stored in continuous spaces of divided; and storing said divided data in the plurality of disk drive units, as logically continued.

Further objects of the present invention will become clear from the following description of the preferred embodiments of the present invention.

### BRIEF DESCRIPTION OF THE DRAWINGS

FIG. 1 is a block diagram of a server system in a VOD system employing a method for storing data according to the present invention.

FIG. 2 is a diagram explaining a concept of the method for storing data according to the present invention.

FIG. 3 is an operation flow chart for initialization in the method for storing data according to the present invention.

FIG. 4 shows an example which composes one group by four disk drive units connected with a SCSI interface according to the present invention.

FIGS. 5A-5C are diagrams showing contents of a table, in a file management section, which is prepared at the operation of the initialization.

### DETAILED DESCRIPTION OF THE PREFERRED EMBODIMENTS

Hereafter, the examples of the present invention will be explained according to drawings as attached. Same reference numbers or reference marks are fixed to the same or similar portions in the drawings.

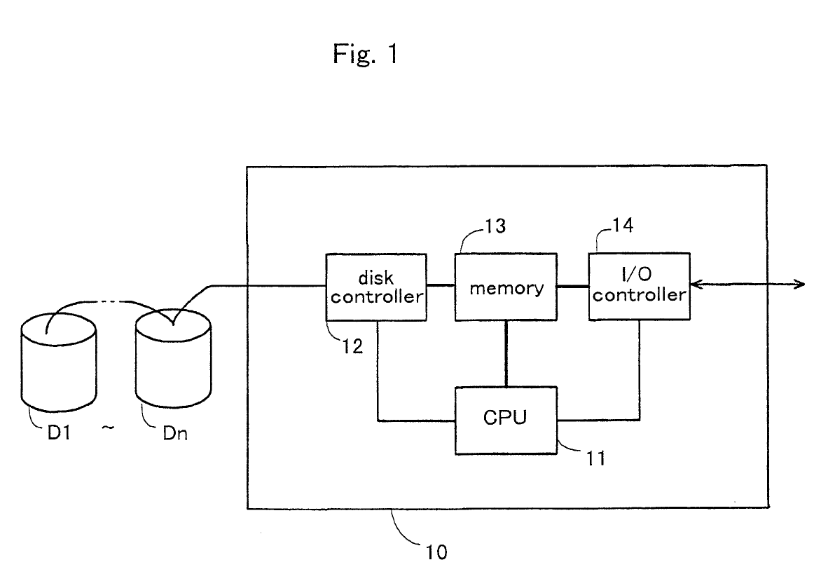

FIG. 1 is an example of a server system of a VOD system employing a method for storing data according to the present invention. Moreover, explanation will be made regarding disk drive units of the logical disk drive unit. However, data of the file are physically divided into four parts, and the divided parts \mathring{1}, \mathring{2}, \mathring{3} and \mathring{4} the file “abcd.dat” are stored in a plurality of disk drive units which are physically independent.

### SUMMARY OF THE INVENTION

In a conventional system, when data of a file are divided as explained above, the order of the division has been decided beforehand. In such the case, it is necessary to fixedly associate physical numbers of disk drive units with numbers of the disk drive units which store the divided data.

Moreover, four disk drive units are formed as a disk group and therefore, only one disk group is provided in the example of FIG. 6, as explained above. For this, when a plurality of disk groups are added, it is necessary to restructure the stored data.

Therefore, it is an object of the present invention is to offer a method for storing data which may solve the problem present in a conventional.

It is a further object of the present invention is to offer a data storage system using the method.

A basic configuration of the data storing method by which the above-mentioned object of the present invention is obtained may include the steps of allocating unique information identifying a disk drive unit to each of a plurality of disk drive units composing a disk group; specifying one of the plurality of disk drive units as a parent disk drive unit, storing information indicating the relation between the disk drive units which compose the group in said parent disk drive unit; dividing data of a file into a plurality connected to the SCSI(Small Computer System Interface) in the following example.

In FIG. 1, a function board 10 has a function of sending out stream data, and disk drive units D1-Dn are connected to the function board 10 through a SCSI interface not shown in FIG. 1. Moreover, the function board 10 is connected with for instance, a personal computer PC or a workstation WS through a PCI bus not shown in the figure.

The function board 10, which has the function of sending out stream data, controls writing to and reading data of a file out from the disk drive units D1-Dn according to commands sent from the personal computer PC or workstation WS connected through the PCI bus.

And, the function board 10 includes a processor 11, a disk controller 12, a memory 13, and an I/O controller 14. The Disk controller 12 has an interface function between the disk drive units D1-Dn and the memory 1. The memory 13 has a buffer function. The I/O controller 14 multiplexes data read out from the memory 13 to convert to ATM (Asynchronous Transfer Mode) cells, and sends the ATM cells to a client side. Moreover, the I/O controller 14 also receives request data sent from the client side, and demultiplexes the received request data.

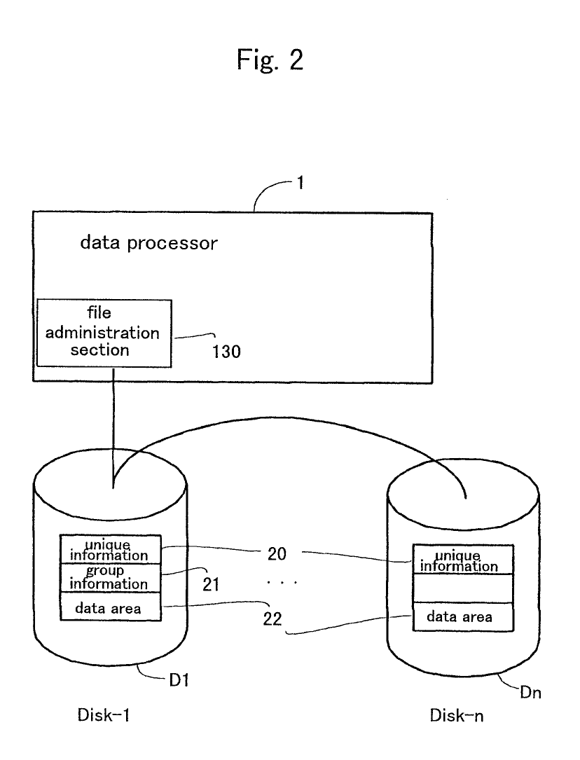

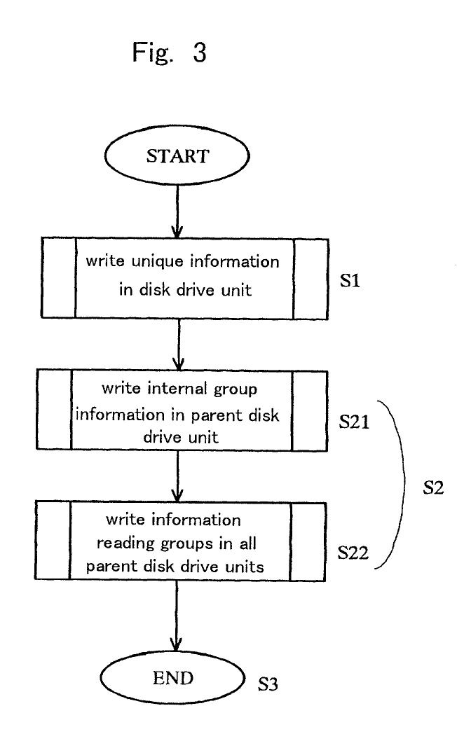

FIG. 2 is a diagram explaining an outline of a method for storing the data of a file according to the present invention. FIG. 3 is an operation flow chart of initialization in the method of storing the data according to the present invention. In FIG. 2, a data processor 1 is a personal computer PC or a workstation WS, connected to the stream data sending function board 10 shown in FIG. 1, but not shown in FIG. 2.

First of all, a unique information 20 is written in the plurality of disk drive units D1-Dn, respectively (Step S1: FIG. 3). The unique information 20 is used to identify individual disk drive units. It is possible to describe construction information of a disk group formed by the plurality of disk drive units D1-Dn, and information regarding relation between disk groups, based on the unique information.

Next, the relation information 21, which indicates relation between a plurality of disk drive units which compose a group is stored in a parent disk drive unit (the disk drive unit D1 is the parent disk drive unit of the group, in FIG. 2) (Step S2: FIG. 2).

Now, the information 21 indicating the relation between the plurality of disk drive units composing a group includes information indicating internal relation of the group and information regarding disk groups. And, the information indicating internal relation of the group is stored in the parent disk drive unit of a corresponding group (step S21). Moreover, the information regarding disk groups is stored in parent disk drive units of all groups (step S22).

The information indicating internal relation of the group includes first information which identifies how a group is composed, that is the number of disk drive units composing the group, and second information which identifies individual disk drive units composing the group, that is, unique information.

The information regarding disk groups is to provide information as to composed groups. For instance, it is an identifier indicating each of a plurality of groups. The information regarding disk groups is recorded on parent disk drive units of all composed groups.

As a result, the divided data are written into data areas 22 with logical continuity, as the initialization operation process ends (step S3).

As mentioned above, it is possible to easily add or delete groups of disk drive units without influencing other groups by using information stored on the disk drive units in the file administration section 130 of the data processor 1. In addition, movement, addition or deletion of disk drive units may be easily made for each of the groups, each of which is composed by a plurality of disk drive units.

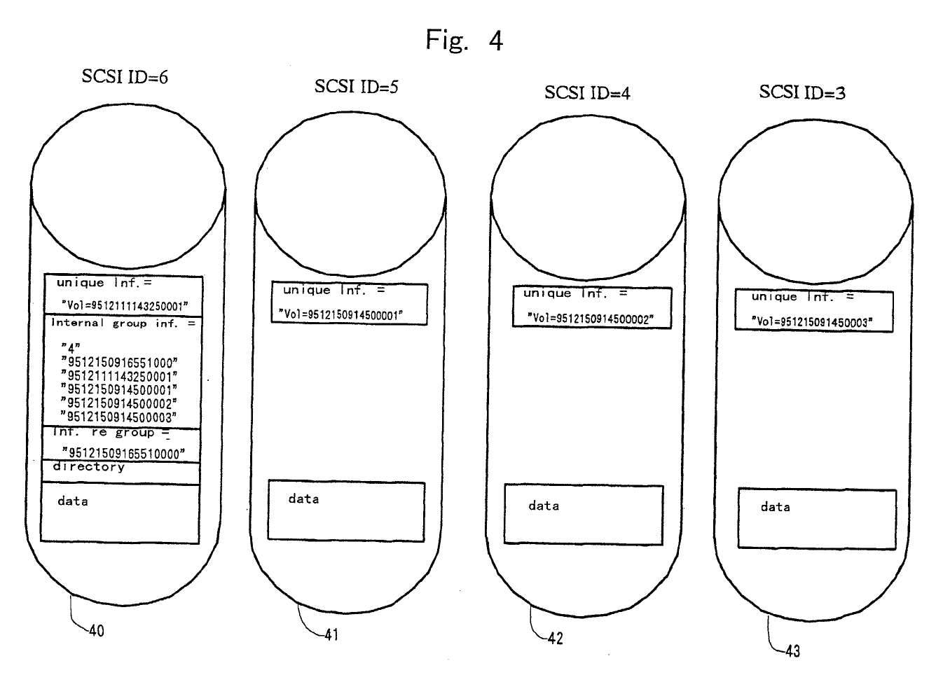

Next, the example of the present invention will be explained concretely. FIG. 4 shows four disk drive units 40-43 connected with the SCSI interface. The disk drive units 40-43 compose one group. The disk drive units 40-43 correspond to 6, 5, 4, and 3 of SCSI-identification numbers, respectively.

The operation of initialization to one group which is formed by the disk drive units in such the form will be now explained.

Time when the initialization operation was done is assumed to be about 9:14 of Dec. 15, 1995. The first processing under the initialization is to write the unique information on each disk drive unit(Step 1: FIG. 3). The unique information here can be set, based on a date.

Therefore, if the initialization is processed as the number 0001 at 1995/12/15 09:43:25, the unique information such as “VOL=9512150943250001” is written in the first sector of the disk drive unit 40. Information starting by “VOL” as head and having figures following the head is the unique information for a disk drive unit subject to be now initialized.

When the unique information is written, it is confirmed whether or not the unique information has already been written to all of the physical disk drive units which can be recognized in the signal and which are connected with the stream data sending function board 10.

In the example of FIG. 4, the information of “VOL=951211114350001” has been already recorded on the first sector of the disk drive unit 40 having the SCSI-ID=6. Because information starting with “VOL” has been stored on the first four bytes, the writing unique information is not further written thereon.

On the other hand, information which starts with “VOL” has not been recorded in the first sector of the disk drive unit 41 of SCSI-ID=5, and then, the information of “Vol=9512150914500001” is written in the first sector as a unique information at the initialization.

In the same way, unique information of “VOL=9512150914500002” is written in the first sector of the disk drive unit 42 of SCSI-ID=4. In addition, unique information of “VOL=9512150914500003” is written in the first sector of the disk drive unit 43 of SCSI-ID=3.

Next, information regarding physical disk drive units which compose a disk group, that is, internal group information is written in a form of a table (Step S21: FIG. 3). This information is stored in the disk drive unit which stores directory information of a file subject to treat.

Because the disk drive unit 40 of SCSI-ID=6 stores the file information in the example of FIG. 4, the internal group information is stored in the second sector of the disk drive unit 40.

The number of disk drive units which compose the disk group is first written. As the group is composed by four disk drive units in the example of FIG. 4, information of “4” is recorded.

Next, information, which is called as a disk group identifier, to identify the disk group, that is, a logical disk is recorded. Numbers are taken by the same method performed when unique information was allocated as information. The information of “9512150916551000” is assigned as the disk group identifier in the example of FIG. 4.

Then, unique information for all the physical disk drive units 40-43 is recorded in the order of storing the data in the disk drive units 40-43. The unique information is recorded in ascending order from the largest number of SCSI-ID in the example of FIG. 4.

Therefore, when the file data are divided and stored, the divided data are stored in the order of SCSI-ID=6, 5, 4 and 3, that is, the order of the disk drive units 40, 41, 42 and 43. The blank is written in the second logical sectors of the disk drive units except the disk drive unit 40 which stores the file information.

In the next processing, information regarding disk groups that are a logical disk is stored (Step 22:FIG. 3). The information is used to manage and identify a plurality of the disk groups. As for this information, the logical disk identifier is described in a table form.

Because only one set of the disk group (logical disk) is present in the example of FIG. 4, “9512150916551000” is stored as the information regarding disk groups.

Next, the processing is performed to obtain a space for recording the directory information, which is used for managing files and which includes as general information, file names, file sizes, date of making files, palaces where data, that are contents of files are stored.

Finally, the area to store the data, which are the content of files is secured and all initialization processes are finished (Step 3: FIG. 3).

The administration for the above-mentioned storage information is performed in such the way that the computer 1, which is explained in FIG. 2, makes a correspondence table, based on the data sent from the processor 11 (FIG. 1) of the stream data sending function board 10, and controls reading out and writing information in each disk drive unit.

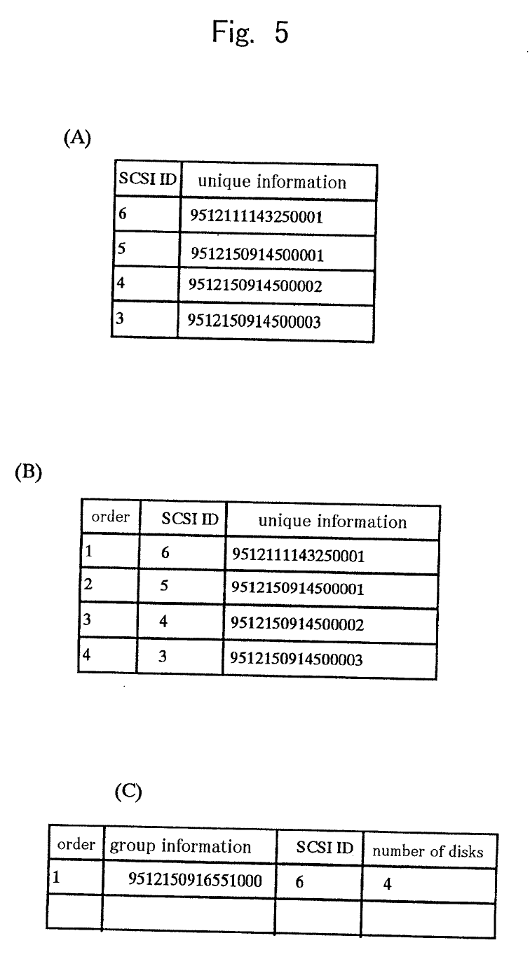

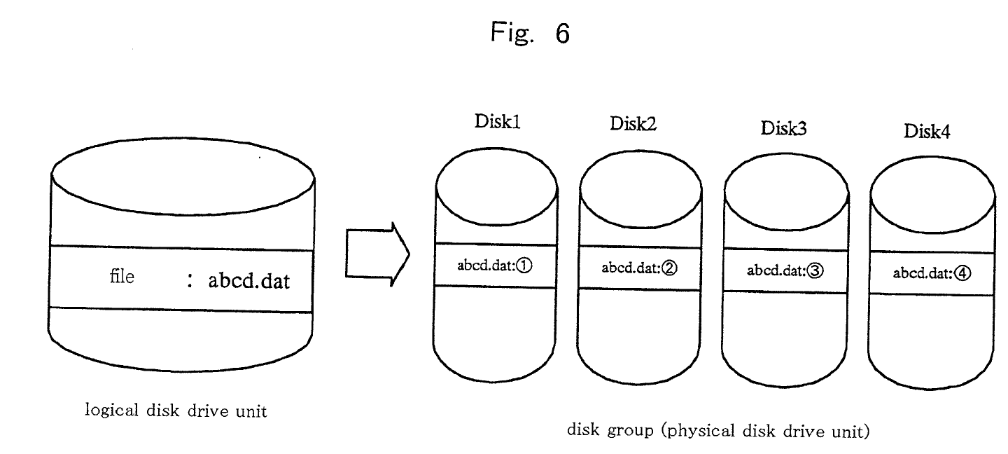

In addition, the process of the method according to the present invention will now be explained from an initial state not being set for anything soon after the power supply is turned on, referring to FIGS. 5A-5C.

The Computer 1 reads the first logical sector to check unique information regarding all the disk drive units 40-43 physically connected. In FIG. 4, the disk drive units 40-43 of SCSI-ID=6, 5, 4 and 3 respectively are checked.

The correspondence table of the checked unique information and SCSI-ID is made in the file management section 130 (FIG. 5A). Next, the second sector is read, and the disk drive unit where the internal group information is stored is checked.

In the example of FIG. 4, the internal group information is stored in the second sector of the disk drive unit 40 of SCSI-ID=6. The blank is stored in the second sectors of other disk drive units 41, 42 and 43.

The first information on the information regarding disk groups means the number of disk drive units, and the number “4” is stored in this case. Disk group identification information then stored. Next, unique information for physical disk drive units which compose a disk group is stored in order of the division of the data file. An information table, which records such information, is maintained in the file management section 130 of the computer 1.

Here, if all of the disk drive units physically connected are not present in the information table and other disk group identification information is stored in the information table regarding disk groups as shown in FIG. 5C, it is confirmed that there are a plurality of disk groups. Therefore, remaining disk group composition information is recorded in the table, by the same process as above-mentioned.

It will now be explained that data of a file are stored in a concrete disk group. The file name is now considered as“foo.dat”. Moreover, volume of the data when completely written is considered as not undecided.

The unit of division is assumed to be 100 Kbyte. The first disk group is chosen because there is only one disk group in the example of FIG. 4. A disk drive unit to which the data unit are first stored, that is, a disk drive unit in which directory information is stored, is now searched from the table shown in FIG. 5B.

It is understood that the searched disk drive unit is the physical disk drive unit 40 of SCSI=6 from the table of FIG. 5B. The number “1” is recorded in a table in the file administration section 130 to mean a disk drive unit first subject to record. Moreover, the file name and the date are written in the directory management area of the physical disk drive unit 40 of SCSI=6, and an empty area for storing data is searched. The preparation for storing the data is now ended.

Next, a writing command is issued from the computer 1, and data are stored temporarily in the computer 1 until the size of divided data becoming 100 Kbytes in the size. When the size of the divided data becomes 100 Kbytes, the temporarily stored data are written in the ample area of the disk drive unit having the writing drive disk unit number “1”, corresponding to SCSI-ID=6.

Next, the number of the writing disk drive unit is increased by “1”. At this time, if the number of the writing disk drive unit is larger than the number of physical disk drive units which compose the disk group, the number of the writing disk drive unit is set to “1” in the table in the file administration section 130.

The data of the file can be stored by repeating the above-mentioned processing until the file is closed.

The necessity for giving regularity to the relation between SCSI-ID and the order of actually writing data is not required, by the administration of the disk drive units being performed according to the above-mentioned method. Therefore, it is only required to allocate SCSI-ID which is empty.

It is also possible to make the above-mentioned table about all of the physical disk drive units after reading information regarding disk groups, while the information regarding disk groups is stored in the disk drive unit 40 in the above mentioned example.

The information regarding disk groups is not necessary to be stored in a disk drive unit in such the case, and further, it is possible to make the internal group information simple by employing the unique information for the disk drive unit which stores directory information as the disk group identifying information.

The present invention may improve portability for each disk group, as the internal group information and the information regarding disk groups are used based on the unique information. That is, it is easy to add and delete drive disk units for each disk group, and therefore, easy construction and reorganization of disk groups become possible as a result.

What is claimed is:

1. A method for storing data of a file in a plurality of disk drive units comprising the steps of:
allocating unique information identifying a disk drive unit to each of a plurality of disk drive units composing a disk group;
specifying one of the plurality of disk drive units as a parent disk drive unit;
storing information indicating the relation between the disk drive units which compose the group in said parent disk drive unit;
dividing the data of the file into a plurality of divided data; and
storing said divided data in the plurality of disk drive units, as logically continued.

2. The method for storing data according to claim 1,
wherein said information indicating the relation between the disk drive units stored in the parent disk drive unit includes information regarding the number of the plurality of disk drive units, and unique information corresponding to respective disk drive units.

3. The method for storing data according to claim 2,
wherein said parent disk drive unit stores group information identifying each of a plurality of groups, each of which is composed by the plurality of disk drive units, as information regarding disk groups.

4. A data storage device for storing data, comprising:
a plurality of disk drive units physically connected and allocated with unique information identifying respective disk drive units composing a group; and
means for assigning one of the plurality of disk drive units as a parent disk drive unit to store information regarding the relation between the plurality of disk drive units in said the parent disk drive unit, and dividing data of a file, and storing the divided data of the file in the plurality of disk drive units, as logically continued.

5. The data storage device according to claim 4,
wherein said information regarding the relation between the plurality of disk drive units includes information regarding the number of the plurality of disk drive units, and unique information corresponding to respective disk drive units.

6. The data storage device according to claim 5,
wherein said parent disk drive unit stores group information identifying each of a plurality of groups, each of which is composed by the plurality of disk drive units, as information regarding disk groups.

7. The data storage device according to claim 5,
wherein said unique information is written in the first sector of each of the disk drive units.

8. The data storage device according to claim 6,
wherein said unique information is written in the first sector of each of the disk drive units.

9. The data storage device according to claim 1,
wherein said parent disk drive unit stores directory information of the file.

10. The data storage device according to claim 4,
wherein said parent disk drive unit stores directory information of the file.
